(19) United States
(12) Patent Application Publication
(10) Pub. No.: US 2024/0341012 A1
(43) Pub. Date: Oct. 10, 2024

(54) HEATER AND ELEMENTS THEREFOR MADE OF PRINTABLE POSITIVE THERMAL COEFFICIENT OF RESISTANCE

(71) Applicant: Purdue Research Foundation, West Lafayette, IN (US)

(72) Inventors: Jacqueline C. Linnes, West Lafayette, IN (US); Riley J. Brown, Hudson, WI (US); Marina Sala de Medeiros, Raleigh, NC (US)

(73) Assignee: Purdue Research Foundation, West Lafayette, IN (US)

(21) Appl. No.: 18/628,212

(22) Filed: Apr. 5, 2024

Related U.S. Application Data
(60) Provisional application No. 63/457,352, filed on Apr. 5, 2023.

(51) Int. Cl. H05B 3/34; H05B 3/03; H05B 3/14

(52) U.S. Cl. CPC H05B 3/34; H05B 3/03; H05B 3/145; H05B 2203/007; H05B 2203/02

(57) ABSTRACT

A heater with positive thermal coefficient of resistance (PTC) elements is disclosed, which includes a substrate and a first and second electrodes spaced apart a predetermined distance from one another and disposed on the substrate, a plurality of conductive strips alternatingly i) extending from the first electrode towards the second electrode terminating by forming an air gap with the second electrode, and ii) from the second electrode towards the first electrode terminating by forming an air gap with the first electrode, one or more resistive elements disposed on each of said alternating conductive strips, thereby making electrical connectivity with a neighboring alternating conductive strip, and a voltage source coupled with both the first and second electrodes, whereby selective voltage of the voltage source determines temperature of the heater.

### CROSS-REFERENCE TO RELATED APPLICATIONS

The present non-provisional patent application is related to and claims the priority benefit of U.S. Provisional Patent Application Ser. 63/457,352, filed Apr. 5, 2023, the contents of which are hereby incorporated by reference in its entirety into the present disclosure.

### STATEMENT REGARDING GOVERNMENT FUNDING

None.

### TECHNICAL FIELD

The present disclosure generally relates to heaters used in bioassays and in particular to a heater with printable positive thermal coefficient of resistance (PTC) elements.

### BACKGROUND

This section introduces aspects that may help facilitate a better understanding of the disclosure. Accordingly, these statements are to be read in this light and are not to be understood as admissions about what is or is not prior art.

Point-of-care (POC) diagnostic tests hold the promise of significantly improving patient care and accessibility by minimizing testing time and need for expensive laboratory equipment. Examples of devices that can offer POC diagnostic tests include antigen tests and nucleic acid amplification tests (NAATs). Antigen tests have often been used because they are low-cost and able to rapidly detect proteins from viruses. However, with limitations of antigen tests in detecting low concentrations of pathogens, NAATs have instead been classified as the gold standard. In NAATs, there is typically a heating element which plays a crucial role in such tests, as elevated temperatures are essential for an incubation step.

According to one authority (World Health Organization), a designed POC device must be capable of maintaining liquid at temperatures between 60° C. and 70° C. for a duration of 30-40 minutes. Presently, many POC tests mandate up to 40 minutes of stable temperatures, necessitating costly and intricate heating platforms requiring external monitoring, such as switching systems, proportional-integral (PI) controllers, and proportional-integral-derivative (PID) controllers to control and minimize the risk of overheating.

There are many types of heater employed, however, in each case cost of the heater as well as complexity of controlling the heater involving external components, place a burden on the simplicity and affordability of such heaters.

Therefore, there is an unmet need for a novel approach that provides a stable heating arrangement that can be achieved at a low cost.

### SUMMARY

A heater with positive thermal coefficient of resistance (PTC) elements is disclosed. The heater includes a substrate and a first and second electrodes spaced apart a predetermined distance from one another and disposed on the substrate. The heater also includes a plurality of conductive strips alternatingly i) extending from the first electrode towards the second electrode terminating by forming an air gap with the second electrode, and ii) from the second electrode towards the first electrode terminating by forming an air gap with the first electrode. Additionally, the heater includes one or more resistive elements disposed on each of said alternating conductive strips, thereby making electrical connectivity with a neighboring alternating conductive strip. Furthermore, the heater includes a voltage source coupled with both the first and second electrodes, whereby selective voltage of the voltage source determines temperature of the heater.

A method of making a positive thermal coefficient of resistance (PTC)-based heater is also disclosed. The method includes providing a substrate. In addition, the method includes printing a first and a second electrode spaced apart a predetermined distance from one another on the substrate. The method also includes printing a plurality of conductive strips on the substrate between the first and the second electrodes, thus making a first combination. Additionally the method includes curing the first combination, thus making a first cured combination. Furthermore, the method includes printing one or more resistive elements on each of the plurality of conductive strips, thus making a second combination. The method also includes curing the second combination.

### BRIEF DESCRIPTION OF FIGURES

FIG. 1 is a schematic of one embodiment of a heater that is based on positive thermal coefficient of resistance (PTC) elements.

FIG. 2a provides schematics of 16 other designs of PTC-based heaters, according to the present disclosure.

FIG. 2b is a photograph representing scanning electron microscopy imaging of a cross-section of the heater, according to the present disclosure.

FIG. 3 is a graph of PTC ratio (i.e., ratio between a resistance RT at a certain temperature T and a resistance R_{TRef} at a reference temperature) vs. temperature which demonstrates that as the temperature subtly increases, the resistance sharply increases further demonstrating a desired self-regulating property.

FIG. 4 is a graph of temperature vs. resistance with a curve-fit formula and a fit measure based on actual data and fitted curve.

FIG. 5 is a graph of resistance vs. design number of FIG. 2a, where the first 14 designs are shown each with the resulting resistance (actual vs. theoretical).

FIG. 6 is a graph of resistance vs. cycles of bending with various bending radii, which demonstrates after 10000 cycles none of the heaters reach failure.

FIG. 7 is a graph of temperature vs. drive voltage for designs 3, 4, and 6 shown in FIG. 2a.

FIG. 8 is a graph of current at 8 V vs. time which shows a steady state value for current of about 50 mA to about 80 mA while the peak transient current is about 206 mA.

FIG. 9 is a schematic which shows the fabrication process of the PTC-based heater, according to the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In the present disclosure, the term “about” can allow for a degree of variability in a value or range, for example, within 10%, within 5%, or within 1% of a stated value or of a stated limit of a range.

In the present disclosure, the term “substantially” can allow for a degree of variability in a value or range, for example, within 90%, within 95%, or within 99% of a stated value or of a stated limit of a range.

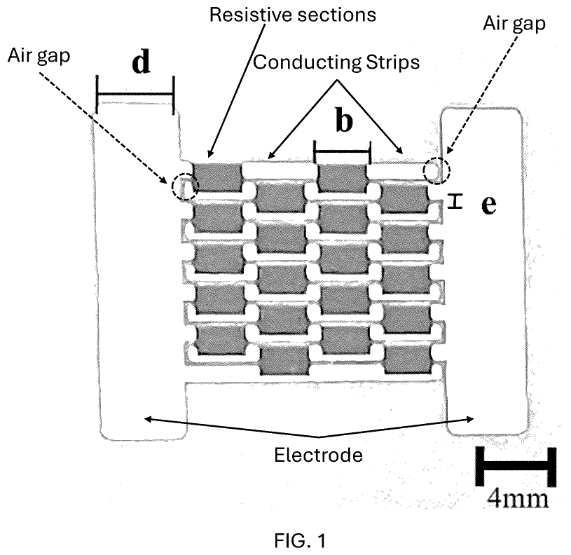

A novel approach that provides a stable heating arrangement that can be achieved at a low cost is disclosed herein. Towards this end, the present disclosure provides a heater made up of positive thermal coefficient of resistance (PTC) elements. These PTC elements can be printed in many different configurations including series and parallel components (in a series configuration, electrical current in all series-connected elements is the same, while in a parallel configuration with two or more branches, voltage across each branch is the same). The heater is made up of two electrodes, typically made of silver but other low-resistance materials are also possible. Additionally, the heater includes a plurality of segments between the two electrodes. Each segment may include a conductive strip of a low-resistance conductor, e.g., made of silver, and sections of high-resistance materials such as carbon placed on the low-resistance strips. These segments can be parallel, series, or a combination of parallel and series. Reference is made to FIG. 1, which is a schematic of one such heater. In FIG. 1, two electrodes are shown, each electrode connected to alternating conducting strips extending from one respective electrode toward the second respective electrode. Resistive elements are then placed according to predetermined pattern to electrically couple one such conducting strip to a neighboring conducting strip. In the heater of FIG. 1, 11 such conducting strips are shown, alternating and extending away from one electrode toward the other electrode. Alternatingly, the conducting strips are terminated prior to making electrical contact with the opposing electrode, thus forming an air gap between end of these alternating strips and the opposing electrode. On each conducting strip there are two resistive elements printed each allowing electrical connection with a neighboring conducting strip below. This pattern is repeated until the last conductive strip which does not originate any resistive elements (thus only 10 conducting strips each with 2 resistive elements resulting in 20 resistive elements). It should be noted that the scale provided in FIG. 1 is for illustrative purposes only and thus no limitation should be associated therewith. In FIG. 1, letter b refers to width of the resistor, letter d refers to width of the electrodes and the letter e refers to center-to-center spacing of the conducting strips.

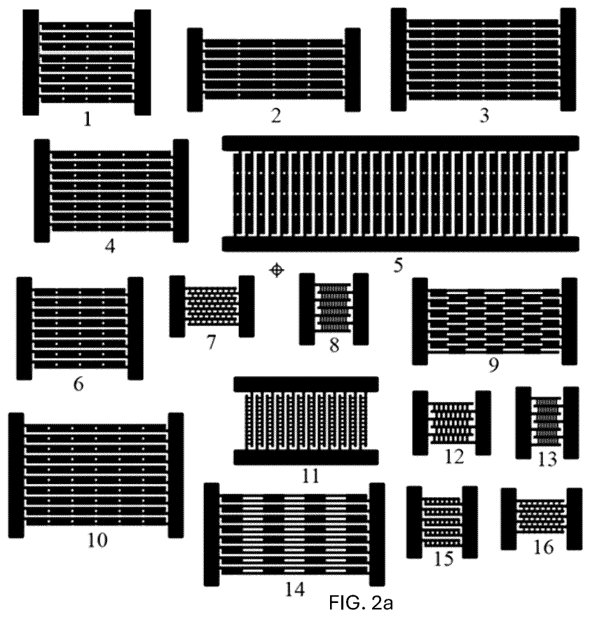

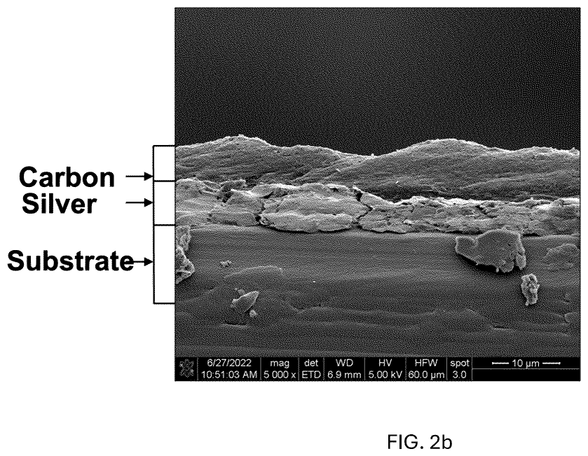

Referring to FIG. 2a, 16 other printed PTC heater patterns are shown, according to the present disclosure. Each of the patterns shown in FIGS. 1 and 2a, generate a different heating pattern and thus can be used to achieve a different desired temperature.

Referring to FIG. 2b, a photograph is shown representing scanning electron microscopy imaging of a cross-section of the heater.

The resistance is calculated using Eq. 1 below:

$$R = \frac{ρ * ( 1 / ( w * h ) ) )}{n} \qquad ( 1 )$$

where, R is the resistance,
p is the resistivity,
l is length,
w is width, and
h is depth or height of the resistive elements. By calculating the resistance and using formula for
n parallel resistors (1/R₁=1/R₁+1/R₂+ . . . +1/Rₙ) provides an approximation for the resistance.

To determine the resistivity of the complex design of the prints, containing silver and 95% Dupont ink, the theoretical resistance was plotted against the measured experimental resistance of 20 heaters on 6 replicates. Next, the resistivity in equation 3 was adjusted until the slope of the line of best fit corresponded with the similarity between theoretical values and experimental values. The temperature of the heater in this section was measured using an infrared (IR) camera (FLIR A300-Series) after reaching equilibrium (˜2 minutes) at 8 V and plotted as a function of resistance. A logarithmic fit was created to describe and predict resistance as a function of temperature. Using this information, a MATLAB script was created that provided various design parameters for specific resistance and temperature values.

Next, the designs were compared experimentally using an RDXLASD Thermometer (Omega Engineering Inc., Norwalk, CT). The heater's resistance was recorded in ambient conditions using the 2-wire Ohm's method via a Digital Multimeter. To measure the temperature, an RDXLASD Thermometer was placed on the backside of the heater which prevented electrical shorts. An insulative foam was placed over the top of the heater to create a closed environment. Heater temperature values were recorded after 4 minutes to improve accuracy.

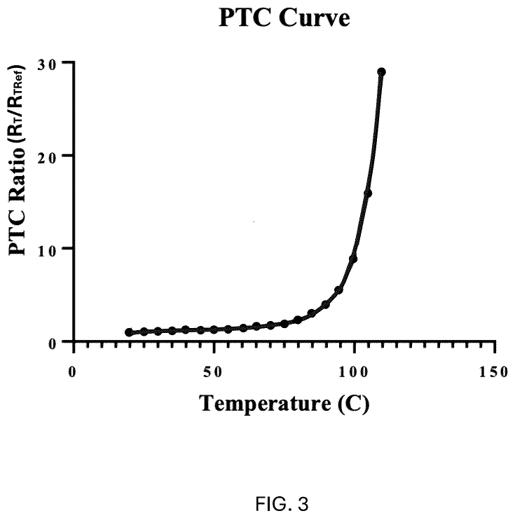

With reference to FIG. 3, a graph of PTC ratio (i.e., ratio between a resistance RT at a certain temperature T and a resistance R_{TRef} at a reference temperature) vs temperature is presented which demonstrates that as the temperature subtly increases, the resistance sharply increases further demonstrating a desired self-regulating property. Another observation from FIG. 3 is that printed ink was found to have a Curie temperature at about 75° C. At this point, the resistance will grow significantly as the temperature increases.

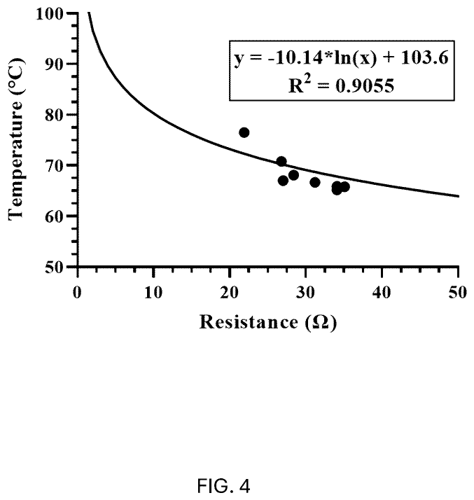

After accounting for resistance decay, temperature and resistance are shown in relations to FIG. 4. The data was curve-fitted with a good R². Based on this, 25-35 ohms is the range to obtain heater temperatures of 68-73° C. To obtain temperatures between 63-78° C., 35-56 ohms is required. Several designs not included in this data include one that had 8× greater spacing between columns of resistors.

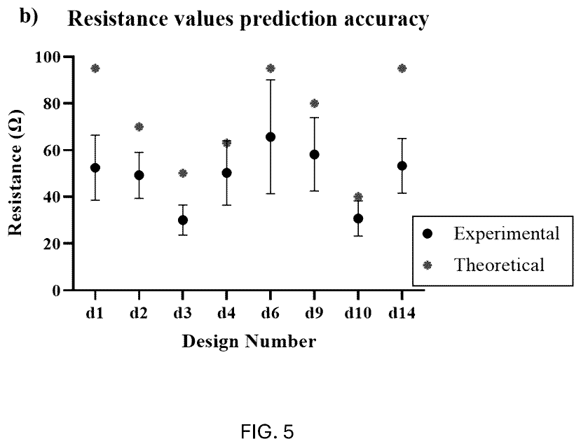

The different design shown in FIG. 2a result in different resistance which then translate to different heater characteristics. Referring to FIG. 5, the first 14 designs shown in FIG. 2a are shown each with the resulting resistance (actual vs. theoretical).

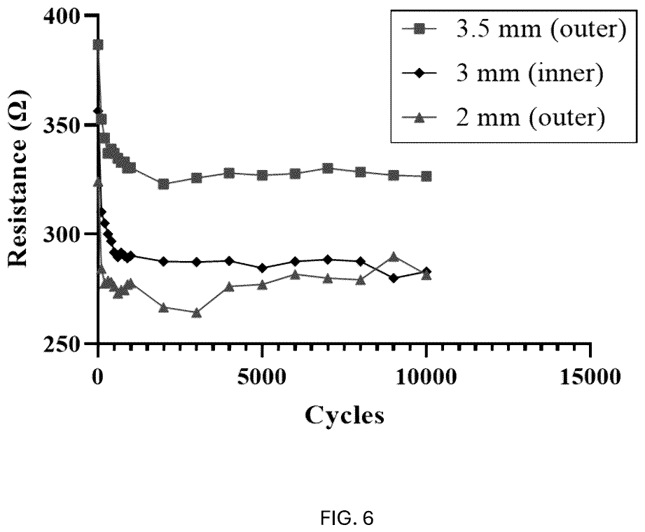

One concern about the PTC heaters discussed herein is fatigue due to bending. To evaluate the physical robustness of the heaters bending fatigue and perforation, studies were conducted. As seen in FIG. 6, which is a graph of resistance vs. cycles of bending with various bending radii, after 10000 cycles none of the heaters reach failure. It should be noted that when the heaters are initially bent, the resistance of the heaters declines.

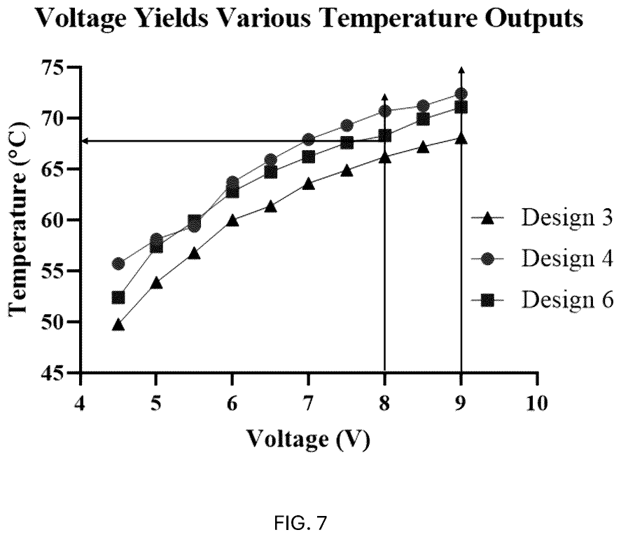

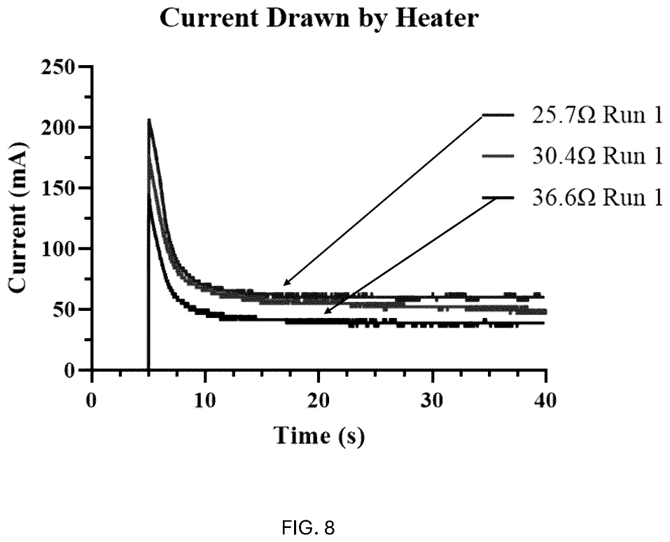

While a variety of voltages can be chosen to drive the PTC heaters, the chosen voltage will have an effect on the temperature that is generated by the PTC heater. Three of the designs (designs 3, 4, and 6 of FIG. 2a) were chosen to determine impact of the drive voltage to the resulting temperature. Referring to FIG. 7, a graph of temperature vs. drive voltage is provided for the aforementioned three designs. For a desired temperature of 65° C., a range of voltages between about 7 V to about 9 V can be chosen. According to one embodiment, about 8 V is the drive voltage for a temperature of about 65° C. Referring to FIG. 8, current at 8 V was measured. The current has a steady state value of about 50 mA to about 80 mA while the peak transient current is about 206 mA, which can be used to ensure the heater can withstand this level of current for a short transient amount of time.

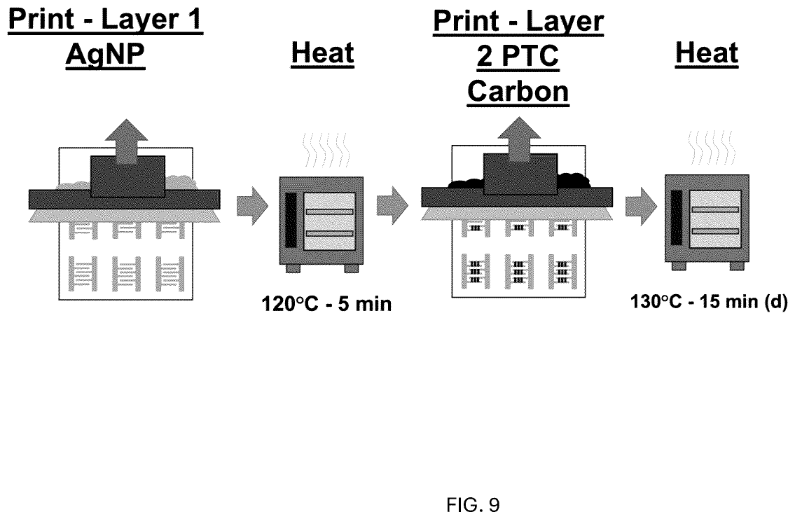

The PTC heater of the present disclosure is fabricated according to a process shown in the schematic of FIG. 9. A Microprinting Systems TF-100 thick film screen printer was used to print the heaters. The screen-printing settings were set to a squeegee pressure of 2.86 kg/cm, squeegee hardness of 70 D, and speed of 10 cm/sec. A manufacturer recommended Kapton FPC polyimide film was used as the printing substrate, which was designed to have low shrinkage upon increased temperature and superior ink adhesion. To cure the ink (i.e., the resistive elements made of carbon), a box oven was set to 120° C. for 5 minutes for the silver ink followed by 130° C. for 15 minutes with the addition of the carbon ink. FIG. 9 shows the steps of assembly. As the first step, the conductive strips and the electrodes are printed on the substrate generating a first combination. Next, the first combination is heated at about 120° C. for about 5 minutes thus generating the first cured combination. Next the resistive elements in the form of carbon segments are printed on the first cured combination, thus generating a second combination. The second combination is then heated at about 130° C. for about 15 minutes.

Those having ordinary skill in the art will recognize that numerous modifications can be made to the specific implementations described above. The implementations should not be limited to the particular limitations described. Other implementations may be possible.

1. A heater with positive thermal coefficient of resistance (PTC) elements, comprising:
a substrate;
a first and second electrodes spaced apart a predetermined distance from one another and disposed on the substrate;
a plurality of conductive strips alternatingly i) extending from the first electrode towards the second electrode terminating by forming an air gap with the second electrode, and ii) from the second electrode towards the first electrode terminating by forming an air gap with the first electrode;
one or more resistive elements disposed on each of said alternating conductive strips, thereby making electrical connectivity with a neighboring alternating conductive strip; and
a voltage source coupled with both the first and second electrodes, whereby selective voltage of the voltage source determines temperature of the heater.

2. The heater of claim 1, wherein the first and second electrodes and the plurality of conductive strips are each made of silver nanoparticles.

3. The heater of claim 1, wherein the plurality of resistive elements are made of carbon.

4. The heater of claim 1, wherein the substrate is a polyimide film.

5. The heater of claim 1, wherein the polyimide film is made of Kapton FPC.

6. The heater of claim 1, wherein the voltage source has a voltage ranging between about 4.5 V and about 9 V, generating a temperature of between about 50° C. and about 70° C.

7. The heater of claim 1, wherein the voltage source has a voltage ranging between about 7 V and 9 V, generating a temperature of between about 65° C. and about 70° C.

8. The heater of claim 1, wherein the voltage source has a voltage of about 8 V, generating a temperature of about 68° C.

9. The heater of claim 1, wherein the voltage source supplies a steady state current of about 50 mA.

10. The heater of claim 1, wherein the voltage source supplies a peak transient current of about 206 mA.

11. A method of making a positive thermal coefficient of resistance (PTC)-based heater, comprising:
providing a substrate;
printing a first and a second electrode spaced apart a predetermined distance from one another on the substrate;
printing a plurality of conductive strips on the substrate between the first and the second electrodes, thus making a first combination;
curing the first combination, thus making a first cured combination;
printing one or more resistive elements on each of the plurality of conductive strips, thus making a second combination; and
curing the second combination.

12. The method of claim 11, wherein the plurality of conductive strips are alternatingly i) extending from the first electrode towards the second electrode terminating by forming an air gap with the second electrode, and ii) from the second electrode towards the first electrode terminating by forming an air gap with the first electrode.

13. The method of claim 12, wherein the one or more resistive elements are disposed on each of said alternating conductive strips, thereby making electrical connectivity with a neighboring alternating conductive strip.

14. The method of claim 11, wherein the first and second electrodes and the plurality of conductive strips are each made of silver nanoparticles.

15. The method of claim 11, wherein the plurality of resistive elements are each made of carbon.

16. The method of claim 11, wherein the substrate is a polyimide film.

17. The method of claim 11, wherein the polyimide film is made of Kapton FPC.

18. The method of claim 11, wherein the step of curing the first combination is by heating the first combination at about 120° C. for about 5 minutes.

19. The method of claim 11, wherein the step of curing the second combination is by heating the second combination at about 130° C. for about 15 minutes.

20. The method of claim 11, further comprising coupling a voltage source to the first and second electrode and applying a voltage therebetween.
